(19) United States
(12) Patent Application Publication
(10) Pub. No.: US 2024/0410196 A1
(43) Pub. Date: Dec. 12, 2024

(54) VEHICLE OPENING PANEL COMPRISING A MEANS FOR BLOCKING THE LOCK IN THE EVENT OF AN IMPACT

(71) Applicant: RENAULT S.A.S., Boulogne Billancourt (FR)

(72) Inventor: Laurent PRUVOST, Guyancourt (FR)

(73) Assignee: RENAULT S.A.S., Boulogne Billancourt (FR)

(21) Appl. No.: 18/700,174

(22) PCT Filed: Oct. 4, 2022
(86) PCT No.: PCT/EP2022/077568

§ 371 Date: Apr. 10, 2024

(30) Foreign Application Priority Data
Oct. 19, 2021 (FR) FR2111085

(51) Int. Cl. E05B 15/00; E05B 79/08

(52) U.S. Cl. CPC E05B 15/0053; E05B 79/08

(57) ABSTRACT

An opening panel for a motor vehicle includes an external panel, an internal panel, an external opening control member for the opening panel, and a lock having an external opening lever that can move such as to allow the opening panel to be opened. The opening panel further includes a structure for blocking the movement of the external opening lever.

The invention concerns an opening panel for a vehicle comprising a means for blocking the lock in the event of an impact. The invention furthermore concerns a vehicle comprising such an opening panel.

A vehicle, in particular a motor vehicle, conventionally comprises at least one opening panel, in particular at least one side front door, equipped with an outer opening control. The outer opening control is generally arranged on an outer panel of the door concerned and comprises a handling means such as a handle controlling a lock. The lock may be arranged on an inner panel of the door concerned and comprises an outer opening lever. An action on the handle causes, via a cable-or linkage-based movement transmission system, a pivoting of the outer opening lever of the lock which has the effect of releasing the lock and consequently opening the door.

However in the event of an impact, for example a side impact on a side door, the outer opening lever of the lock is pivoted up to its position releasing the lock, the effect of which is to open the door. In fact, because of various parasitic phenomena caused by the impact, such as e.g. deformation and/or displacement of the handle, deformation and/or displacement of the transmission system, and the inertia of certain elements, the outer opening lever of the lock undesirably pivots open. Such an untimely opening of the door is dangerous and contrary to regulatory requirements. It is therefore desirable that a door deformed by an impact remains closed so as to ensure its function of protecting the occupants of the vehicle.

In this sense, it is known to integrate an active reinforcement in the opening panel, extending from the front to the rear of the door and equipped with an active zone opposite the lock, in particular in the form of a hook, which enters the pivoting volume of the lever in the case of deformation of the opening panel and blocks the lock. Such reinforcements have the disadvantage of being bulky, making them sometimes unsuitable in the presence of elements of the opening panel such as a waist reinforcement, and heavy, which affects the mass of the vehicle and its fuel consumption. In addition, it has been found that, in certain situations, the active reinforcement is moved by the impact such that it becomes ineffective, for example because it rises outside the pivoting zone of the lever.

The present invention falls within this context and aims to provide a vehicle opening panel remedying the disadvantages above. In particular, the invention proposes an opening panel for a motor vehicle, in particular a side door, comprising an outer panel facing the outside of the vehicle, an inner panel, an outer opening control of the opening panel, in particular at least partially fixed to the outer panel, a lock, in particular at least partially fixed to the inner panel, the lock comprising an outer opening lever of the lock configured to be moved, under the effect of a command to open the opening panel on the outer opening control, between a rest position in which the outer opening lever blocks the lock and a release position in which the outer opening lever releases the lock so as to allow opening of the opening panel. The opening panel also comprises a means for blocking the movement of the outer opening lever:
the blocking means extends at least partly opposite the inner opening lever in a first direction transverse to the opening panel of the vehicle, and in a second direction orthogonal to the first direction and in particular parallel to a longitudinal direction of the vehicle;
the blocking means is arranged at least partly on the outer panel and has a concave structure relative to the outer panel, extending toward the inner panel so as to block the movement of the outer opening lever along a trajectory between the rest position and the release position, before this reaches the release position, in the case of impact deforming the outer panel, in particular in the case of side impact in at least a first direction;
the blocking means has at least a first contact surface intended to form a stop for the outer opening lever and configured to extend transversely to the movement trajectory of the outer opening lever when the outer panel is deformed.

The blocking means may have a dimension in the second direction of less than 300 mm, in particular less than 200 mm, even less than 150 mm.

The first contact surface may lie in an end portion, in particular a rear end portion, of the blocking means in the second direction.

The blocking means may comprise a U-shaped or substantially U-shaped profile. A first flat and a second flat of the blocking means form the arms of the U, at least one of the first flat or second flat may carry a lug for directly or indirectly fixing the blocking means to the outer panel, and at least one base of the U connecting the first flat and the second flat extends at a distance other than zero from the outer opening lever when the outer panel is not deformed.

The first flat may comprise the first contact surface. The first flat may have a slope α relative to the base, in particular a slope between 15 and 40°, even between 20 and 30°.

The opening panel may comprise at least one obstruction element configured to block a movement of the blocking means in a third direction, orthogonal to the first direction and to the second direction, in the case of impact deforming the outer panel, the obstruction element being configured to come into contact with a second contact surface of the blocking means separate from the first contact surface.

The second contact surface may extend at least partly opposite the first contact surface in the third direction.

The obstruction element may be arranged such that in the case of impact deforming the outer panel, the blocking means is at least partially interposed between the outer opening lever and the obstruction element in the third direction.

The opening panel may comprise a waist reinforcement extending at least partly between the outer panel and the inner panel, the blocking means being integral with the waist reinforcement.

In particular, the blocking means may be attached and fixed by gluing and/or screwing and/or welding to the waist reinforcement on one side and to the outer panel on the other.

The invention also concerns a vehicle, in particular a motor vehicle, characterized in that it comprises an opening panel, in particular a side front door, as claimed in one of the preceding claims.

Further details, features and advantages will arise more clearly from reading the detailed description below, given by way of indication and without limitation, with reference to the various exemplary embodiments illustrated in the following figures:

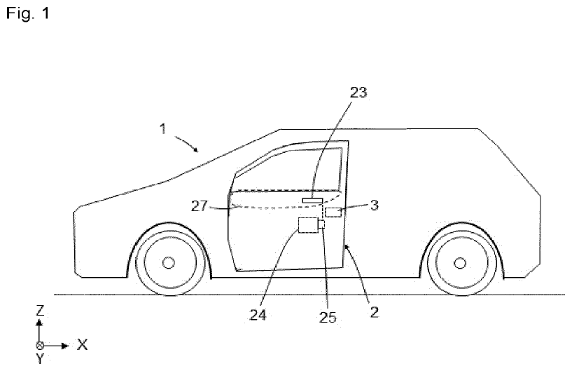

FIG. 1 is a schematic view of a vehicle according to one embodiment.

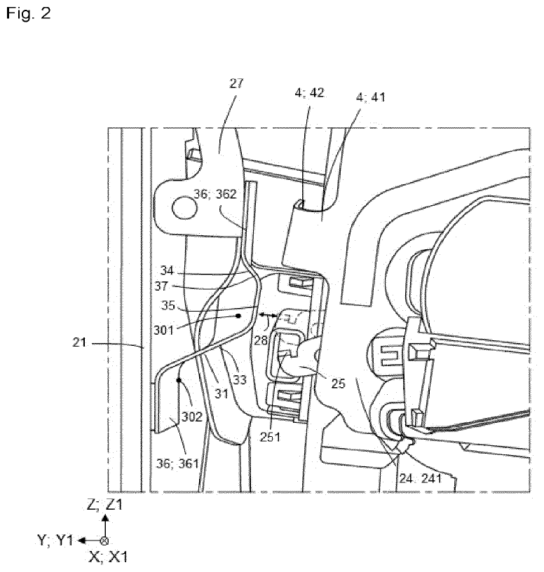

FIG. 2 is a schematic view from the side of a left side opening panel of the vehicle, comprising a means for blocking a lock in the event of an impact.

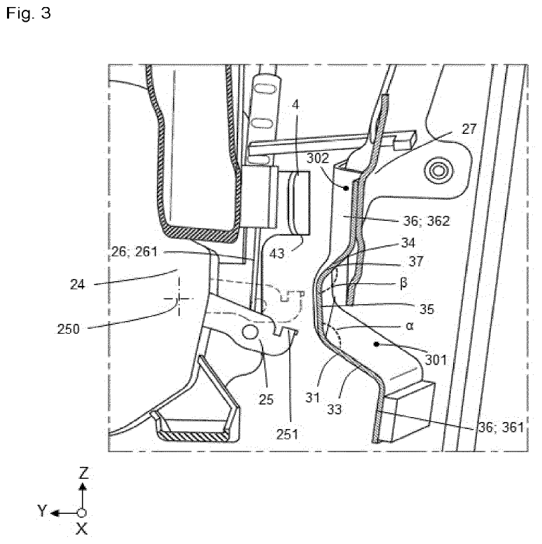

FIG. 3 is a schematic cross-sectional view of the opening panel from the side.

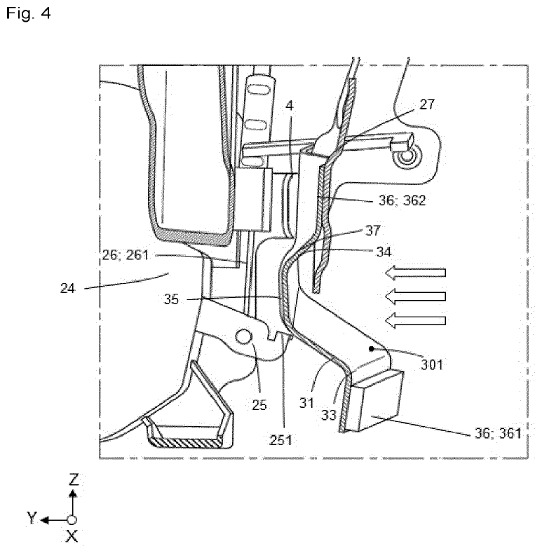

FIG. 4 is a schematic representation of the opening panel illustrated in FIG. 3 in the case of an impact.

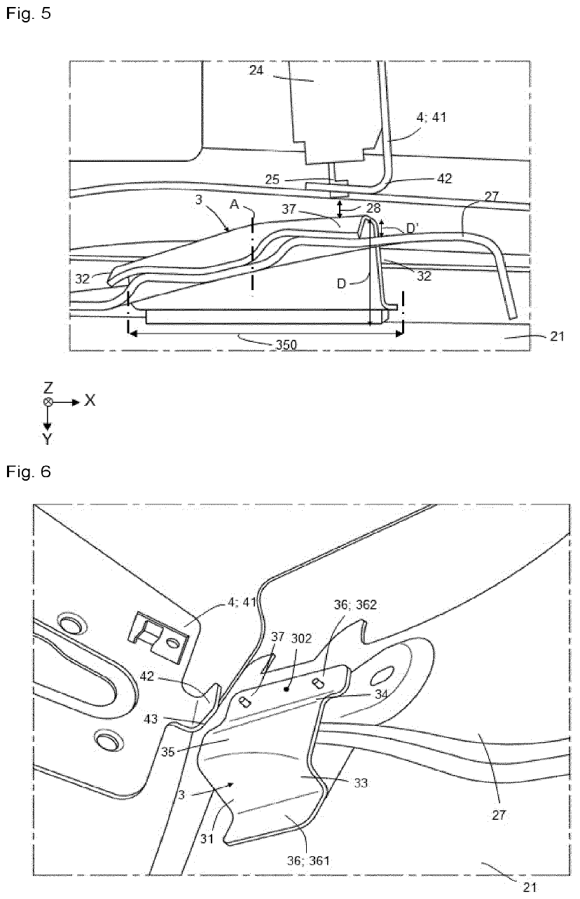

FIG. 5 is a top view of the opening panel.

FIG. 6 is a perspective view of the interior of the opening panel.

FIG. 1 illustrates schematically an embodiment of a vehicle 1, in particular a motor vehicle 1. The vehicle 1 comprises at least one opening panel 2, preferably of the side type. In particular, the opening panel 2 is a side front door. For reasons of clarity, the opening panel 2 described below is the left side front door of the vehicle 1; it is nonetheless understood that such a representation is in no way limitative.

By convention in the description which follows, the direction of movement of a motor vehicle 1 in a straight line is defined as being the longitudinal direction X. The forward direction corresponds to the direction in which the motor vehicle 1 normally moves in the longitudinal direction and is opposite to the backward direction. The direction perpendicular to the longitudinal direction in a plane parallel to the ground is called the transverse direction Y. The direction perpendicular to directions X and Y is called the vertical direction Z. This defines a direct frame of reference XYZ shown in the figures where required.

Also, “inner” means the side nearest the interior of the passenger compartment of the vehicle 1. Similarly, “outer” means the side opposite the interior of the passenger compartment, i.e. that closest to an environment external to the vehicle 1 in the direction Y. Finally, “lower” means the side closest to the ground on which the vehicle 1 is standing, and “upper” means the side furthest from the ground or highest in the direction Z.

The opening panel 2 comprises a box section with at least one outer panel 21 and an inner panel (not shown). For example, such panels may be made of aluminum alloy or sheet steel.

As illustrated, the opening panel 2 comprises an outer opening control 23. Preferably, the outer opening control 23 may be at least partly fixed to the outer panel 21. The outer opening control 23 may comprise, according to non-limitative examples, a handle mounted pivoting, in particular around a substantially horizontal axis or around a substantially vertical axis, a push-button and/or a hand or finger detection surface. Optionally, the outer opening control 23 is able to communicate with an electronic object such as a key, a card, a badge or a telephone, allowing actuation of the outer opening control 23.

Also, the opening panel 2 comprises a lock 24. The lock 24 may be at least partly fixed to the inner panel of the opening panel 2. It comprises an outer opening lever 25 configured to be moved, under the effect of a command to open the opening panel 2 on the outer opening control 23, between a rest position illustrated in solid lines in FIGS. 2 and 3 and a release position illustrated in dotted lines. In the rest position, the lever 25 blocks the lock 24. Consequently, in the rest position of the lever 25, if the opening panel 2 is in the closed position, the opening panel 2 is held closed. In the release position, the lever 25 releases the lock 24. Consequently, in the release position of the lever 25, if the opening panel is in the closed position, the outer opening lever 25 releases the lock 24 to allow opening of the opening panel 2.

In particular, the outer opening lever 25 is mounted pivoting around a pivot axis 250 extending longitudinally or substantially longitudinally when the opening panel 2 is closed. Preferably, the lever 25 extends in the rest position and/or the release position and/or any intermediate position between said positions and in the direction of the outer panel 21 when the opening panel 2 is in the closed position, a free end 251 of the lever 25 being moved within the box section. The free end 251 protrudes for example relative to a housing 241 or structure containing or covering the lock 24.

In the example illustrated, the free end 251 of the lever 25 pivots clockwise and rises to pass from the rest position to the release position. Conversely, to move from the release position to the rest position, the lever 25 pivots anticlockwise so as to drop. According to a variant embodiment (not shown) of another embodiment of the lock, the lever pivots anticlockwise and drops to pass from the rest position to the release position. Conversely, to shift from the release position to the rest position, the lever pivots clockwise so as to rise.

“Command to open the opening panel” here means an action or force exerted by a user to actuate the outer opening control 23 and consequently the lock 24. The opening command may for example be a pivoting or pulling of a handle, pressing on a push-button or touching of a surface, depending on the above-mentioned types of outer opening control. In this sense, the opening panel 2 preferably comprises a mechanism or system 26 for transmitting a movement and/or information between the outer opening control 23 and the lever 25 of the lock 24, allowing movement of the latter between the rest position and the release position in particular. For example, the transmission system 26 may comprise one or more linkages (not shown), and/or at least one cable 261 associated with at least one sheath visible in FIG. 3.

Optionally but preferably, as illustrated in FIGS. 1 to 6, the opening panel 2 comprises a waist reinforcement 27 which extends at least partly in the box section between the outer panel 21 and the inner panel in the transverse direction Y. In FIGS. 3 and 4, the outer panel 21 is not shown for reasons of clarity, these figures illustrating a cross-sectional view along an axis A shown in FIG. 6. In FIG. 6, the lock is not shown, so as to reveal the blocking means. The waist reinforcement 27 extends for example longitudinally or substantially longitudinally in the closed position of the door. Depending on the vehicles concerned, the waist reinforcement 27 may also extend opposite or substantially opposite the outer opening control 23 in the transverse direction Y. In addition, the waist reinforcement 27 is arranged and/or shaped so as not to interfere with the movements of the lever under normal conditions. In other words, the waist reinforcement 27 extends at a distance other than zero from a trajectory or pivoting zone of the lever 25. It may in particular be offset in the transverse direction Y and/or vertical direction Z relative to the lever 25.

The opening panel 2 furthermore comprises a means 3 for blocking the movement, in particular the pivoting, of the lever 25. The blocking means 3 is fixed or substantially fixed relative to the opening panel 2, in particular relative to the outer panel 21, when the opening panel 2 is in the normal condition, i.e. when the opening panel 2 is not deformed by an impact. The blocking means 3 is in particular at least partly arranged directly and/or indirectly on the outer panel 21 and is shaped so as to extend toward the inner panel.

Preferably, the blocking means 3 is made of a metal material, for example folded sheet metal, in particular a sheet of steel or aluminum alloy. Alternatively, the blocking means 3 is at least partially shaped from foam, preferably rigid foam, in particular polystyrene. Rigid foam means for example a foam that it is difficult to compress.

In particular, the blocking means 3 may be integral with the waist reinforcement 27. According to one exemplary embodiment, the blocking means 3 is attached and fixed by gluing and/or screwing and/or welding to the waist reinforcement 27 on one side and/or to the outer panel 21 on the other. In this case, the blocking means 3 is fixed by screwing or welding, at least at one point, to the waist reinforcement 27 such that it forms an integral part of the reinforcement. The blocking means 3 is preferably fixed by gluing, at least at one distinct point, to the outer panel 21. The blocking means 3 is glued to the outer panel 21 for example via a glue and/or an adhesive, e.g. of the double-sided type as illustrated. The use of gluing at the outer panel 21 serves in particular to maintain the appearance and external design of the vehicle 1.

According to a variant embodiment, the gluing means is fixed only by gluing to the outer panel 21, with no specific fixing then being provided at the waist reinforcement 27.

Such an arrangement advantageously prevents the generation of noise due to vibrations of the blocking means 3 relative to the outer panel 21, in particular when the longitudinal speed of the vehicle 1 increases.

According to alternative (not shown), the blocking means 3 and the waist reinforcement 27 are integral. The blocking means 3 may then at least partly be directly held fixed relative to the outer panel 21 by gluing.

The blocking means 3 is configured to block the movement of the outer opening lever 25 before this reaches the release position, or substantially reaches the release position, in the case of impact deforming the outer panel 21. In other words, the blocking means 3 is designed to obstruct the trajectory of the outer opening lever 25 between its rest position and its release position, as will be explained in more detail below. In particular, such an impact may be a side impact occurring in a first direction Y1, which may be parallel to the direction Y.

The blocking means 3 has a concave structure relative to the outer panel 21 and/or the waist reinforcement 27. The assembly formed by the blocking means 3 and the outer panel 21 thus defines a hollow shape in which an outer surface 301 of the blocking means 3, facing toward the outer panel 21, extends at least partly at a distance other than zero from said panel. In other words, at least a part of the blocking means 3 protrudes from the outer panel 21 and has an offset D in the first direction Y1, in particular toward the inner panel. Such an offset D is in particular evaluated between the outer panel 21 and a point of the blocking means 3 furthest away in the first direction Y1. When the vehicle comprises a waist reinforcement 27, the blocking means then protrudes from the outer panel 21 and from the waist reinforcement 27, and has in the first direction Y1 an offset D relative to the outer panel 21 and an offset D′ relative to the waist reinforcement 27.

The offset D is greater than 15 mm, it may particular be between 20 and 75 mm. The offset D is a function of a predefined distance 28 between the end of the lever 25 and the blocking means 3, so as not to obstruct the pivoting of the lever. The integrity of the blocking means 3 is essential to its function during an impact, so the distance D is preferably constant on compression of the door following a side impact. The offset D′ is greater than 10 mm, it may in particular be between 15 and 50 mm. In this way, the blocking means 3 may stop the lever 25 rapidly after the start of the impact against the outer panel 21.

The blocking means 3 has at least a first contact surface 31 able to come into contact with the outer opening lever 25 when the outer panel 21 is deformed, and intended to extend transversely to the movement trajectory of the outer opening lever 25 before the lever 25 reaches the release position or substantially reaches the release position. In other words, the blocking means 3 interrupts the movement of the lever 25 in an intermediate position or alternatively in the rest position. The first contact surface 31 thus corresponds to a surface against which, on the basis of various modelled types of impact, in particular side impacts, a part of the lever 25, for example the free end 251 of the lever 25, comes to abut.

The blocking means 3 extends at least partly opposite the inner opening lever 25 in the first direction Y1 and in a second direction X1 orthogonal to the first direction Y1. In particular, the second direction X1 is parallel to the longitudinal direction X of the vehicle 1. Preferably, when the lever 25 is pivoted, the blocking means 3 extends at least opposite the pivot axis 250 of the lever 25 in the first direction Y1.

Also preferably, the first surface 31 extends in the second direction X1, i.e. in the longitudinal direction X, when the opening panel 2 is closed. In fact for optimal blocking of the end of the lever 25 in the case of impact, the first contact surface 31 is positioned at the lever 25 in the longitudinal direction when the opening panel is closed. This location allows the surface to form a stop for the lever 25 whatever the deformations of the outer panel 21 and/or of the waist reinforcement 27.

In the exemplary embodiment illustrated, the first contact surface 31 lies in an end portion, in particular a rear end portion, of the blocking means 3 in the second direction X1. “End” means that such a portion comprises an edge 32 delimiting the blocking means 3 in at least one direction, in this case in the longitudinal direction X.

Advantageously, the blocking means 3 has a dimension 350 in the second direction X1 which is less than 300 mm, in particular less than 200 mm, or even less than 150 mm, for example of the order of 80 mm. The dimension 350 concerned is in particular defined between two opposite edges 32 delimiting the blocking means 3 in the second direction X1. The resultant bulk and the additional on-board weight are thus limited in comparison with conventional blocking means.

Preferably, the first surface 31 also has in the second direction X1, a dimension of more than 30 mm, for example a dimension between 40 and 100 mm, or of the order of 60 mm. The first surface 31 is longitudinally offset toward the front of the lever 25 by a distance of at least 30 mm and toward the rear of the lever 25 by a distance of at least 10 mm.

FIGS. 2 to 6 illustrate a particular exemplary embodiment of the blocking means 3 in which the blocking means 3 comprises a U-shaped or substantially U-shaped profile. In particular, the blocking means 3 comprises a first flat 33 and a second flat 34 forming the arms of the U, and at least one base 35 of the U connecting the first flat 33 and the second flat 34 together. The first and second flats thus extend on one and the same side of the base in the first direction X1 when the blocking means 3 is positioned in the opening panel. Preferably, connecting zones between the base 35 and the various flats 33, 34 have a rounded form.

The base 35 extends at a distance other than zero from the outer opening lever 25 when the outer panel 21 is not deformed, and is interposed between the first flat 33 and the second flat 34 on one side and the lever 25 on the other in the first direction Y1.

At least one of the first flat 33 or second flat 34 carries a lug 36 for directly or indirectly fixing the blocking means 3 to the outer panel 21. In this case, the first flat 33 carries a first lug 361 and the second flat 34 carries a second lug 362. As explained above, the first lug 361 is attached by gluing directly to the outer panel 21. The second lug 362 is attached by screwing to the waist reinforcement 27, itself mounted on the outer panel 21. To this end, the waist reinforcement 27 comprises at least one fixing screw intended to pass right through the blocking means 3, in particular at its fixing lug 36.

On an impact deforming the outer panel 21, it is essential to ensure firstly that the outer opening lever 25 is properly blocked, but also that it is blocked rapidly, i.e. preferably in the rest position or in an intermediate position remote from the release position, for example closer to the rest position than to the release position. It is also essential not to obstruct the functioning of the outer opening lever 25 under normal conditions, i.e. the blocking means 3 must not obstruct or hinder the movement of the lever 25 when there is no deformation of the outer panel 21.

Thus the first flat 33 comprises the first contact surface 31. The first flat 33 here corresponds to the flat of the blocking means 3 with the lowest position, i.e. closest to the ground. To optimize the moment at which the lever 25 is blocked when an impact takes place, and so as not to obstruct the trajectory, the first flat 33 may advantageously have a slope a relative to the base 35. In particular, such a slope a is between 15 and 40°, or between 20 and 30°.

Also in this sense, the positioning of the blocking means 3 relative to the lever 25 may be optimized in the first direction Y1. In particular, the blocking means 3 may be arranged such that a point of an inner surface 302 of the blocking means 3, opposite the outer surface 301 and facing the inner panel of the opening panel 2, closest to the lever 25, lies in the first direction Y1 at a distance of less than 20 mm, in particular a distance of less than 15 mm, for example between 3 and 10 mm, from the free end 251 of the lever 25 when the latter is in the release position. Such a distance is here illustrated by the distance 28.

Optionally but preferably, the opening panel 2 may also comprise an element 4 for obstructing the blocking means 3. The obstruction element 4 is configured to block a movement of the blocking means 3 in the third direction Z1, orthogonal to the first direction Y1 and the second direction X1, in the case of impact deforming the outer panel 21. In particular, said third direction Z1 is parallel to the vertical direction Z.

In particular, the obstruction element 4 is intended to limit an upward movement of the blocking means 3. In fact in the example illustrated, an upward movement of the blocking means 3 could, depending on the extent of such a movement, either prevent the blocking of the lever 25 or delay such a blocking, in particular to the point that the blocking is performed in the release position or substantially in the release position, or beyond this, which would lead to the opening of the opening panel 2.

The obstruction element 4 is designed to form a stop for a second contact surface 37 of the blocking means 3, separate from the first contact surface 31, so as to limit the movement of the blocking means 3 in the vertical direction Z. The second contact surface 37 extends at least partly facing the first contact surface 31 in the third direction Z1. In this case, the second contact surface 37 lies in the second flat 34 of the blocking means 3.

Also in this sense, the obstruction element 4 extends at least partly facing the outer opening lever 25 in the third direction Z1, in particular facing the free end 251 of the lever 25 when the latter extends in the release position.

Thus the obstruction element 4 is arranged such that, in the case of impact deforming the outer panel 21, the blocking means 3 is moved so as to be at least partly interposed between the outer opening lever 25 and the obstruction element 4 in the third direction Z1. Here, the obstruction element 4 has a position that is higher, in the third direction Z1 and hence in the vertical direction, than that of the outer opening lever 25 so as to prevent the rising of the blocking means 3.

Preferably, the obstruction element 4 extends in the second direction X1, when the opening panel 2 is closed, in particular at least over a dimension of more than 20 mm. Also, the obstruction element 4 extends at least partly at the level of the lever 25 and the blocking means 3 in the second direction X1. Preferably, the obstruction element 4 is positioned above the lever 25 over at least a distance of 10 mm in the second direction X1 on either side of this vertical line.

According to various non-limitative alternatives, the obstruction element 4 may comprise a lock reinforcement 41, normally used for fixing and positioning the lock 24 during assembly of the opening panel 2, a part of the lock 24, e.g. the housing 241 or a fixing thereof, or a sheet-metal element mounted inside the opening panel 2 and extending in the box section.

In this case, the obstruction element 4 comprises the lock reinforcement 41. The obstruction element 4 is attached and mounted inside the box section of the opening panel 2. Preferably, the obstruction element 4 and the lock 24 are mounted on one and the same panel. Here, the obstruction element 4 is mounted on the inner panel and extends toward the outer panel 21, the inner panel being less susceptible to being impacted, or to a lesser extent in the case of impact. The lock reinforcement 41 comprises an L-shaped attachment 42, an end segment of which is designed to form a stop for the blocking means 3. “Segment” here means a part of a whole. The end segment may be a straight, curved or angled piece. In particular, the end segment extends in the longitudinal direction when the opening panel 2 is closed.

Preferably, the obstruction element 4 comprises at least one lower edge 43, i.e. closest to the ground, which is straight and able to come into contact with the blocking means 3, in particular the second contact surface 31. In this case, such an edge 43 lies in the end segment of the attachment 42 and extends in the second direction X1.

Similarly to what has been explained above with reference to the first flat 33 and first contact surface 31, the second contact surface 37 may lie in one of the end portions of the blocking means 3. In particular, the second contact surface 37 may lie in the rear end portion of the blocking means 3, such that the first contact surface 31 and the second contact surface 37 lie in the rear end portion of the blocking means 3 in the second direction X1. In an alternative (not shown), the second contact surface 37 may lie in an opposite front end portion of the blocking means 3. Also, in addition or alternatively, the second surface 37 may have in the second direction X1 a dimension greater than 30 mm, for example a dimension between 40 and 100 mm, even of the order of 60 mm.

In addition, optionally but preferably, the second flat 34 has a slope β relative to the base 35, in particular a slope β between 15 and 40°, even between 20 and 30°. The second flat 34 is also sloping relative to the first flat 33. Such a slope is intended in particular to direct the blocking means 3 toward a position suitable for blocking the lever 25 if the blocking means 3 moves in the third direction Z1, here in the vertical direction Z. The attachment 42 of the obstruction element 4 may also advantageously have a slope relative to the edge 43 and to the third direction Z1, such that the blocking means 3 may be guided during an impact.

In this way, in normal operation as illustrated in FIGS. 2 and 3, i.e. not in the case of an impact on the outer panel 21 of the opening panel 2, the lever 25 is moved freely, here pivoting around the axis, via the transmission system 26, following a command on the outer opening control 23. The blocking means 3 does not then obstruct the movement of the lever 25 and extends at a distance other than zero from a free end 251 thereof. The lever 25 moves freely between the rest position and the release position. In this case it rises freely beyond the first contact surface 31, e.g. until it extends opposite the base 35 in the first direction Y1. In other words, the first contact surface 31 is not at any time in contact with the free end 251 of the lever 25.

During an impact applied in the first direction Y1 from the outside of the vehicle 1 toward the inside of the vehicle 1, against the outer panel 21 of the opening panel 2, as indicated by the arrows in FIG. 4, the outer panel 21 deforms by folding. As a result, the outer panel 21 draws closer to the inner panel. The blocking means 3, mounted directly and/or indirectly on the outer panel 21, moves in the first direction Y1 toward the inner panel as shown in FIG. 4. The blocking means 3 is then positioned transversely to the trajectory of the outer opening lever 25. In particular, the first contact surface 31 comes to form a stop for the free end 251 of the lever 25 before this reaches the release position, for example in the rest position or in an intermediate position, in particular close to the rest position. The blocking means 3 rapidly stops the movement of the lever 25 because of its position and shape. The lever 25 is then blocked and unable to move into its release position. The untimely opening of the lock 24 and consequently the door is prevented, despite the various parasitic phenomena or factors created by the impact. In other words, in case of impact, although these phenomena generate the equivalent of a door opening command and consequently a reaction of the lever 25 toward the release position, the blocking means 3 stops the lever 25. In fact in the case of deformation of the outer panel 21, the first contact surface 31 interferes with the start of travel of the end 41 in the rest position or in an immediate position.

Thus protection of the occupants is ensured by keeping the door closed following the impact. In the case of a side impact on a side door, the door does not open accidentally, the blocking means countering the consequences of the parasitic phenomena tending to open the door. The vehicle equipped with such a door then complies with regulations and consequently can be approved.

The present invention thus proposes an opening panel comprising a blocking means mounted directly and/or indirectly on an outer panel of the opening panel. The solution proposed is advantageously lightweight, which reduces the mass of the vehicle and limits its fuel consumption. It is also compact and therefore has no effect on the standard elements constituting the opening panel, and may be applied to various models of vehicle.

Although the solution is particularly suitable for a side impact on a side door, in particular on a side front door, the solution may extend to a side rear door. Alternatively, the door may be a tailgate extending substantially vertically and transversely in the closed position, the solution ensuring that the tailgate remains closed in the case of rear collision.

The present invention is not however limited to the means and configurations described and illustrated here, and also extends to any equivalent means or configuration and to any technically feasible combination of such means insofar as they ultimately fulfill the functionalities described and illustrated in the present document.

1-10. (canceled)

11. An opening panel for a motor vehicle, comprising:
an outer panel facing an outside of the vehicle;
an inner panel;
an outer opening control of the opening panel;
a lock comprising an outer opening lever configured to be moved, under an effect of a command to open the opening panel on the outer opening control, between a rest position in which the outer opening lever blocks the lock and a release position in which the outer opening lever releases the lock so as to allow opening of the opening panel; and
means for blocking the movement of the outer opening lever, wherein
the blocking means extends at least partly opposite the inner opening lever in a first direction transverse to the opening panel of the vehicle, and in a second direction orthogonal to the first direction,
the blocking means is arranged at least partly on the outer panel and has a concave structure relative to the outer panel, extending toward the inner panel so as to block the movement of the outer opening lever along a trajectory between the rest position and the release position, before the outer opening lever his reaches the release position, in the case of impact deforming the outer panel, and
the blocking means has at least a first contact surface configured to form a stop for the outer opening lever and configured to extend transversely to the movement trajectory of the outer opening lever when the outer panel is deformed.

12. The opening panel as claimed in claim 11, wherein the outer opening control of the opening panel is at least partially fixed to the outer panel.

13. The opening panel as claimed in claim 11, wherein the lock is at least partially fixed to the inner panel.

14. The opening panel as claimed in claim 11, wherein the blocking means extends parallel to a longitudinal direction of the vehicle.

15. The opening panel as claimed in claim 11, wherein the impact deforming the outer panel is a side impact in at least a first direction.

16. The opening panel as claimed in claim 11, wherein the blocking means has a dimension in the second direction of less than 300 mm.

17. The opening panel as claimed in claim 11, wherein the first contact surface lies in an end portion of the blocking means in the second direction.

18. The opening panel as claimed in claim 11, wherein the first contact surface lies in a rear end portion of the blocking means in the second direction.

19. The opening panel as claimed in claim 11, wherein the blocking means comprises a U-shaped or substantially U-shaped profile, a first flat and a second flat of the blocking means forming arms of the U, at least one of the first flat or second flat carrying a lug for directly or indirectly fixing the blocking means to the outer panel, and at least one base of the U connecting the first flat and the second flat, extending at a distance other than zero from the outer opening lever when the outer panel is not deformed.

20. The opening panel as claimed in claim 19, wherein the first flat comprises the first contact surface, the first flat having a slope relative to the base of between 15 and 40°.

21. The opening panel as claimed in claim 11, further comprising at least one obstruction element configured to block a movement of the blocking means in a third direction, orthogonal to the first direction and to the second direction, in the case of the impact deforming the outer panel, the obstruction element being configured to come into contact with a second contact surface of the blocking means separate from the first contact surface.

22. The opening panel as claimed in claim 21, wherein the obstruction element is arranged such that, in the case of the impact deforming the outer panel, the blocking means is at least partially interposed between the outer opening lever and the obstruction element in the third direction.

23. The opening panel as claimed in claim 11, further comprising a waist reinforcement extending at least partly between the outer panel and the inner panel, the blocking means being integral with the waist reinforcement.

24. The opening panel as claimed in claim 23, wherein the blocking means is attached and fixed by gluing and/or screwing and/or welding to the waist reinforcement on a first side and to the outer panel on a second side.

25. The opening panel as claimed in claim 11, wherein the opening panel is a side door.

26. A vehicle, comprising:
the opening panel as claimed in claim 11.

27. The vehicle as claimed in claim 26, wherein the opening panel is a side front door.
